(19) United States
(12) Patent Application Publication
(10) Pub. No.: US 2017/0021393 A1
(43) Pub. Date: Jan. 26, 2017

(54) Grill Cleaning Device

(71) Applicant: James Hasler, Bristol, CT (US)

(72) Inventor: James Hasler, Bristol, CT (US)

(21) Appl. No.: 15/202,506

(22) Filed: Jul. 5, 2016

Related U.S. Application Data
(60) Provisional application No. 62/195,713, filed on Jul. 22, 2015.

(51) Int. Cl. B08B 1/00; A47J 37/07

(52) U.S. Cl. CPC B08B 1/005; A47J 37/0786

(57) ABSTRACT

An improved grill cleaning device/tool is presented for removing the baked and charred food, grease and sauce particles which build up over during to create an unsanitary, unappetizing and uneven grill surface on the grates. The tool design allows the cleaning of both the top and bottom of a set of two grates (grill rods) without removing the grilling surface. The tool consists of a handle, rigid shaft and a shaped scraping blade. In a preferred embodiment the blade is die cut from tempered spring steel, having a thickness of about 1/32 inch. The shaft is made from 303 stainless steel and the handle is made from a machinable, durable thermoplastic such as polyoxymethylene/polyacetal thermoplastic available as Delrin.

### BACKGROUND OF THE INVENTION

Field of the Invention

This invention relates generally to the field of devices, tools for cleaning grates or grill rods of grills where charcoal, gas or wood are used to cook food, including fish, meat, vegetables, fruits, etc. Typically, such barbeque grills tend to build up deposits of charred foods, which require removal for sanitary reasons.

Description of Related Art

There are a number of grill tool cleaning devices over the years but no design is really totally satisfactory. Some appear to be relatively easy to use, but usually are either too one dimensional, too complex in construction, or not made of the best materials.

Ohers are complex in design, costly to produce and thus have higher cost to a grill owner/user.

Others are complex to use, may require multiple adjustments to fit a particular grill grate design. Most of the simpler constructions do not clean multiple surfaces or grates very well or easily. Not all are scrapping devices, as some employ wire bristles to scratch clean the grates. These latter generally require the grill grate to be removed from the grill structure to reach the side facing the charcoal or burner. Surfaces between grates are harder to truly clean with ‘brush type devices too.

Sampling of grill tool patented designs and operation includes the following patents, which can be broken out by whether they clean primarily a single surface/grate or multiple surfaces on more than one grate on each stroke.

Single grate/surface prior art includes the following.

U.S. Pat. No. 3,820,185 C. D. Phillips (1974) describes cleaning portions of a single grate/rod. The twisted handle can handle underside with its multiple bends in a twisted flat extension from a round handle. Two slots need to be cut into cleaning blade, twist differs for right or left handed use. Tool works on one rod at a time, requires extra dexterity for proper use and tool is designed for either a left handed or right handed operator.

U.S. Pat. No. 4,858,403 L. I. Martin (1990) device cleans surfaces on a single grate/rod. Very complex action is needed in use to clean one grate or section of a grate at a time, difficulty with gross rod along grate length, etc. Hard to imagine cleaning while grill surfaces still hot as it would appear that free hand or extra hand maybe be needed to control grill as the device is used to line up with the cleaning surfaces so need to use multiple hands in operation. Also easy to see how a grill with significant adhering food particles could easily jam up the scraping mechanism.

U.S. Pat. No. 4,214,342 P. D, Amundsen (1980) describes a single grate/rod cleaning device, which is quite compact, however this leads to major limitations. Small size leads to little leverage or distance from hot grill surface. Much more action needed and force needed especially for larger grill surfaces. Due to very short/small size it is hard to use before allowing some time for cooling, as the hand will be only an inch or so above the hot cooking surface, even worse if one tries to clean an undersurface without removing grill from heating area.

U.S. Pat. No. 4,112,537 R. W. Heuck (1978) scrapes a single grill rod, with a wheel having different sizes. The fixed groove, larger than all wheel grooves, lines up with selected groove from wheel; but torque on rivet remains a real probability. The riveted wheel has several sized grooves for use with different sized/shaped grill grates/rods. The product however is likely to become damaged in use due to its design as material accumulates between the bar extension from the handle and the brass wheel. The stationary scraping edge is the leading edge for the cleaning/scraping strokes. Larger particulate can be forced between the fixed edge and the wheel, producing extra stress on the rivet point. Very small gap is also hard to be keep clean.

Multiple surface on different grates prior art includes the following.

U.S. Pat. No. 5,373,500 S. Stojanovski et al. (1994) deals with cleaning multiple surfaces on adjacent grates/rods, but also using both scraping and brushing action to clean. A brush and scraper are used in combination but the combo compromises each mode of operation. Additional problems arise from plastic handle wire brush in too close proximity to heat; scraping edges again called for 1/16 thick, as most others. Overall the complex structure raises as many problems as it tries to solve in relation to simpler scraping only cleaning devices.

U.S. Pat. No. 5,720,071 D. L. Hall (1998) describes a multiple surface/grate cleaning device. It has lots of flexibility to clean numerous grill grates; however the complex adjustable tines, require tightening each one carefully to obtain uniform scraping of grate sides. Setup for specific grill gate spacing is time consuming, and even if set and kept constant, the many nut/bolt combination are subject to becoming loose or moving under strong scraping action, which can lead to less efficient or missed cleaning. Further the design yields less direct contact on top surface of grate, and virtually no contact below, without removing grill from stand to clean bottom side.

U.S. Pat. No. 5,987,693 R. A. Noga (1999) presents another approach to clean multiple surface on different grates/rods. It has less adjustments than Hall, but more complex action needed to get tops and sides scraped well, due to gaps arising from complex shape of the scraping surfaces relative to handle design.

A more recent approach by U.S. Pat. No. 7,275,278 B1 Martin et al. (2007) is a variant of cleaning surfaces on a single grate/rod. It requires a brass cleaning blade with very specific compositional ranges of metals, among other aspects. Besides the specific material requirements for the blade, it resembles the multi-scraping device of Heuck (1978), but the wheel is securely fastened to the rod/handle by the tapped thread within the blade and further secured with a cap nut. As noted earlier, a major limitation is that only one grate/rod can be addressed at a time. Also as designed it is not easy to access the bottom of the grate/rod without removed the entire grill from its structure.

The problem of efficient, easy cleaning of grate cooking surfaces on grills still is looking for a simple though elegant solution, which is reliable, durable and can be offered at modest prices. The present invention offers a more complete solution to cleaning of grilling surfaces such as grates/rods above and below the grilling surface without necessitating removal of the grill surface from the grill substructure.

### BRIEF DESCRIPTION OF THE DRAWINGS

The following drawings further describe by illustration the advantages and objects of the present invention. Each drawing is referenced by corresponding figure reference characters within the “DETAILED DESCRIPTION OF THE INVENTION” section to follow.

FIG. 1. illustrates a preferred embodiment of the present invention.

FIG. 2. shows the scraper blade engaged for a preferred embodiment of the present invention in contact with typical grate rods from above the grilling surface

FIG. 3. illustrates additional detail of a preferred embodiment of the present invention in relation to a typical grill, where the blade is below the grilling surface.

FIG. 4. shows a detailed view of a preferred scraping blade embodiment of the present invention.

FIG. 5. is a detailed illustration of a preferred shaft/rod embodiment of the present invention.

FIG. 6. illustrates details of a preferred handle embodiment of the present invention.

FIG. 7. presents some alternative blade configurations of preferred embodiments of the present invention.

### BRIEF SUMMARY AND OBJECTIVES OF THE INVENTION

It is an objective of the present invention to provide a grill cleaning tool which is easier to use, simple to manufacture, rugged and sturdy, and highly durable.

The present invention provides an improved grill cleaning device for removing the baked and charred food, grease and sauce particles which build up over during to create an unsanitary, unappetizing and uneven grill surface on the grates. The tool design allows the cleaning of both the top and bottom of a set of two grates (grill rods) without removing the grilling surface. The tool consists of a handle, rigid shaft and a shaped scraping blade. In a preferred embodiment the blade is die cut from spring steel, having a thickness of about 1/32 inch. The shaft is made from 303 stainless steel and the handle is made from a machinable, durable polyoxymethylene/polyacetal thermoplastic such as Delrin or Celcon.

### DETAILED DESCRIPTION OF THE INVENTION

In view of the limitations now present in the prior art, the present invention provides a new and useful Grill cleaning tool/device which is simpler in construction, resistant to the outdoors, and more versatile in operation than other grill cleaning tools, which are currently available. The present invention is a sturdy, weather resistant toll easy to employ and modest in cost due to its manufacturing simplicity.

A typical outdoor grill creates charred food along the grill rods or grates which make up the grilling surface. Meat, fish skin, fat sauces, etc. all contribute to the charred residue after grilling food on the grilling surface. Cleaning of the surfaces is needed before each use for both sanitary and aesthetic reasons. Ideally the cleaning will be done just preceding or just after the grill being turned off. Generally cleaning is more complete and efficient when the grilling surface is still warm/hot rather than cold.

The tool design, herein presented, allows the cleaning of both the top and bottom of a set of two grates (grill rods) without removing the grilling surface. This is a benefit so that the soiled/charred grill surface does not need to be removed to access the lower surfaces and thus can be done with the grill still at elevated temperatures.

To minimize rusting or degradation of the various components of the grill cleaning tool/device, materials are chosen which do not rust or degrade in outdoor settings, due to temperature or sunlight. Specifically non-rusting metals are used for the rigid shaft of the tool and selected for their reliable strength in use around the grill. In preferred embodiments 303 stainless steel or aircraft-grade aluminum is used to fashion the shaft. Likewise steel is used for the blade, but the preferred grade is tempered spring steel, which is die cut to make the specific shape of the blade out of 1/32 inch stock. Using tempered spring steel allows use of the much thinner stock blade material which makes a sharper edge as it is die cut and which allows more complex shapes cut into the blade compared to the scraping edges offered in the prior art.

In one preferred embodiment, the handle is made from a weather resistant thermoplastic having good machining properties and can maintain tight tolerances. It should also have temperature resistance, so that grill cleaning can be done while the grill is about to be shut off or shortly after it is started for its next use. These are the best times to efficiently scrape clean the grill grates/rods and benefit from the features of the present invention. Desired properties in the handle material include high abrasion resistance, low water absorption, and high heat resistance. A preferred material for the handle is polyoxymethylene,(CH₂O)ₙ, polymer or co-polymer, which is marketed under numerous brand names including Delrin, Celcon, Duracon, Hostaform and Ramtal. The surface of the handle is preferentially textured during manufacture to facilitate a sure grip during use.

The scraping blades as mentioned earlier are die cut from a 1/32 inch thick sheet of tempered spring steel to provide a durable sharp edged scraper. The pattern has a thicker central section whose width is slightly smaller the distance between adjacent grates on most cooking grills. The extensions right and left are mirror equivalents with sections ‘cut out’ to provide half radial surfaces, mimicking generally the radius of grill rods, or alternatively having shapes complementary to the grate design so that the scraper blade closely approaches the grate surface during back and forth scraping action.

The blade is securely fastened to the end of the rigid shaft opposed to the handle by an adequate means. In one preferred embodiment a machine screw is used to secure the blade to the shaft. Another means for securing the blade to the shaft would involve having the end of the shaft designed for a river tip, where the blade is secured by a rivet.

In one preferred embodiment the shaft and handle are manufactured from a solid aircraft grade aluminum rod, which is turned down in the shaft portion to maintain low weight.

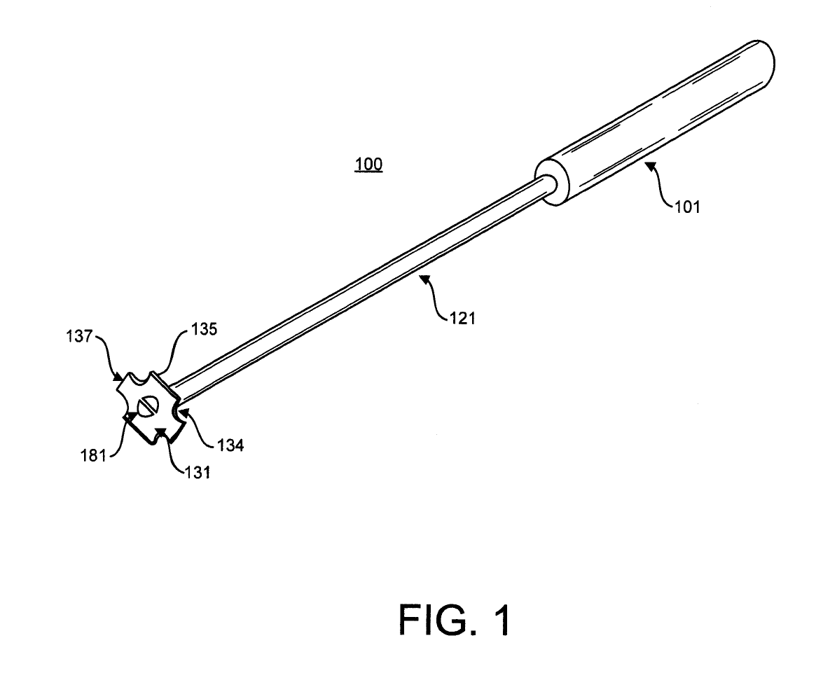

A preferred embodiment of the present invention is illustrated in FIG. 1. Grill cleaning tool 100 comprises handle 101, rigid shaft 121 and scraping blade 131. Blade 131 is securely fastened to shaft 121 with machine screw 181. Scrapping edges 134 have a radius substantially equal to the radius of the grill grate/rods.

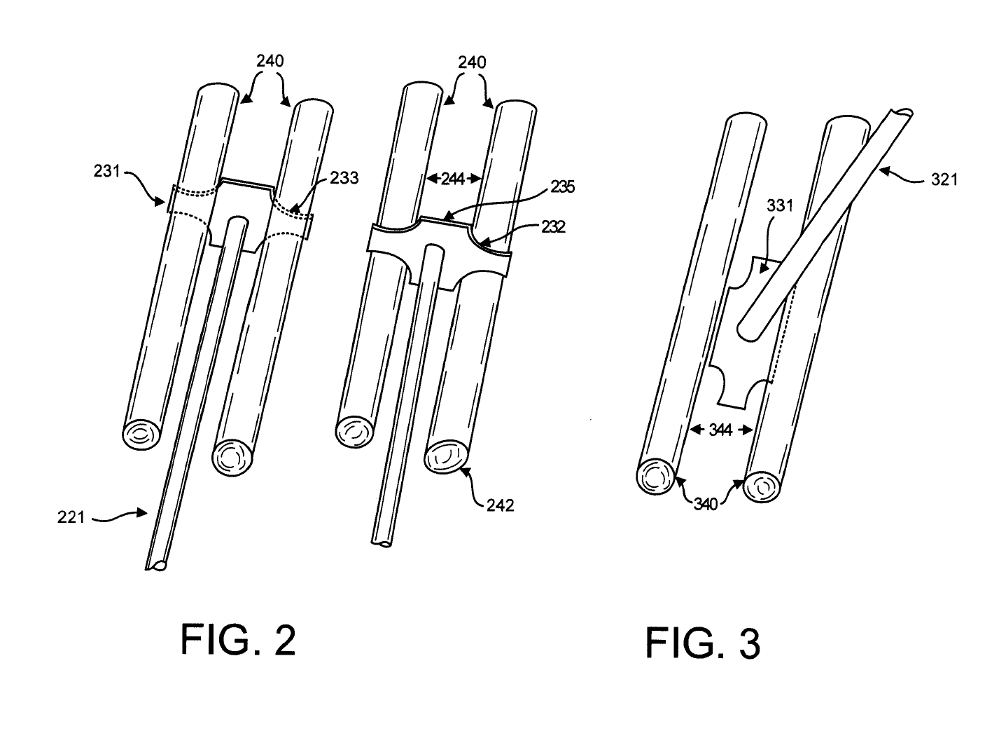

In FIG. 2, adjacent grill rods 240 are being scraped with a forward and back stroke, using shaft 221 to push-pull blade 231 in contact with the surfaces on the two rods, which have radius 242. Thickness 235 of the blade is shown along with radius 232 cut into blade 231.

By moving shaft 321 and blade as shown in FIG. 3, scrapping device/tool can be passed through adjacent grill rods 340 and then pivoted 90 degrees so as to scrape clean the bottom side of the grill grate/rods 340. The spacing/gap 344 between adjacent grill rods is shown in reference to the width of blade 331.

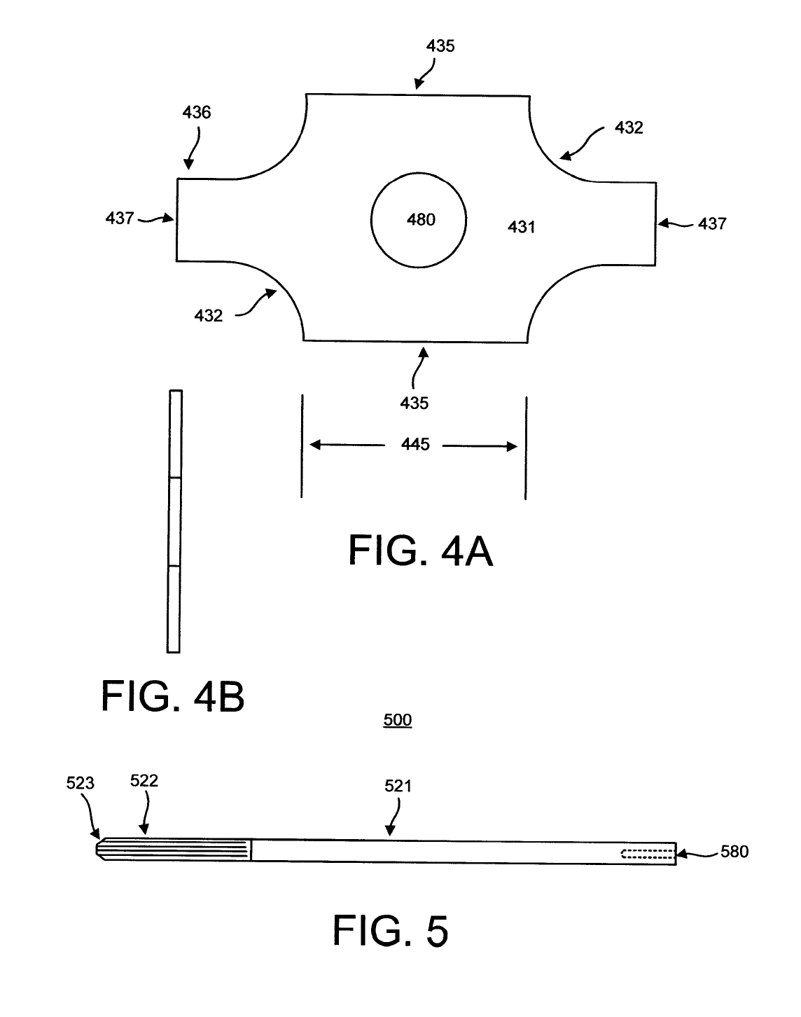

Significant detail of blade 431 is presented in FIG. 4. Scraper edge 435 whose width 445 is just slightly less than gap 344 between adjacent rods from the prior figure. Outer edges 437 of blade 431 can be slightly wider 436 than blade wing at radius 432 position to help scrape rounded grill rod 340 (FIG. 3) on surface opposite gap 344 between adjacent rods 340. Center hole 480 is where screw 181 (FIG. 1) will secure blade 131 to shaft 121.

Aircraft grade aluminum or 303 stainless steel are preferably used for shaft structure 500, where shaft/rod 521 is designed as illustrated in FIG. 5 for component of a preferred embodiment. Coarse section 522 cover the end which will be pressed into a handle section. At its end there is small beveled section 523. Dimensions shown are typical and are not necessarily drawn to exact scale. Opposite the handle end of shaft 521, there is threaded hole 580 cut into shaft 521. Its depth and dimensions will depend on the dimensions of the machine screw (181) used to secure the cleaning blade (131) to shaft 521.

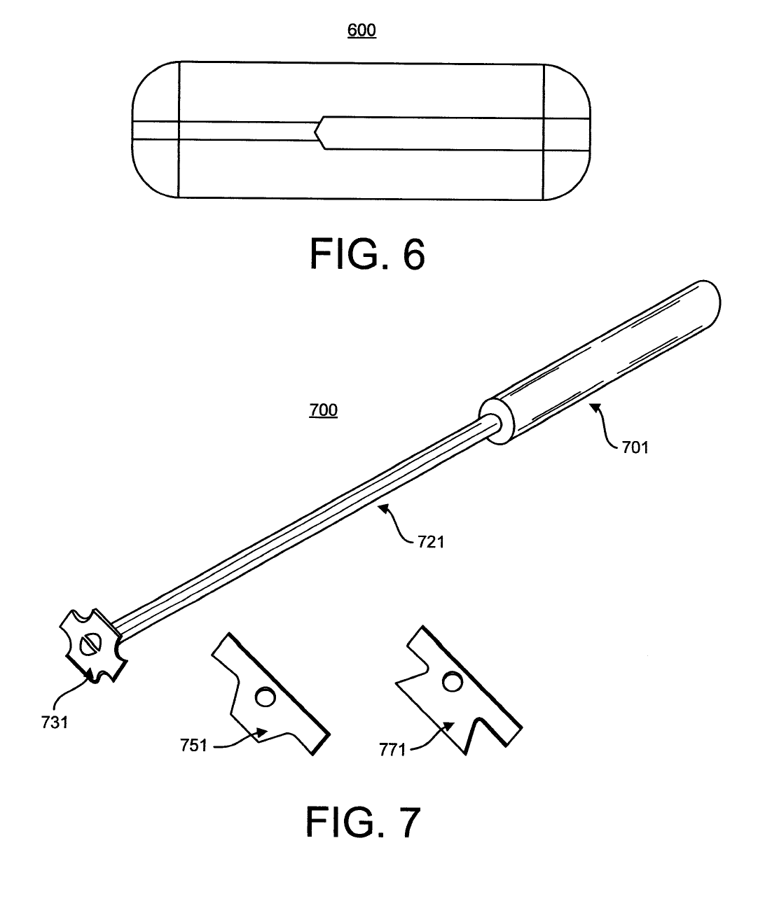

Handle assembly 600 is depicted in FIG. 6. Dimensions and marks depict typical dimensions to be a compatible component with shaft and blade depicted* in the accompanying figures.

In FIG. 7, are depicted a sample cleaning tool/device 700 with three examples of preferred embodiments of blade, namely 731, 751 and 771.

Having described preferred embodiments of the invention with reference to the accompanying drawings, it is to be understood that the invention is not limited to these precise embodiments, and that various changes and modifications may be effected therein by one skilled in the art without departing from the scope or spirit of the invention as defined in the appended claims, including changes in application or method of use or operation, method of manufacture, shape, size, or material which are not specified within the detailed written description or illustrations contained herein yet would be apparent or obvious to one skilled in the art.

What is claimed is:

1. A grill cleaning device comprising; a handle, a metallic shaft and a shaped scraping blade; wherein said shaft connects said handle and said blade, wherein said blade scraping surface is configured to clean multiple surfaces on a grill, including portions of two grates at a time; wherein said blade is securely fastened to said shaft, and wherein said rod is securely fits into said handle.

2. The device according to claim 1, wherein said shaped blade is made of tempered spring steel.

3. The device according to claim 1, wherein said shape is preferably selected from that shown in FIGS. 4 and 7.

4. The device according to claim 2, wherein said blade of tempered steel is 1/32 inch thick.

5. The device according to claim 1, wherein said shaft is made from a material selected from the group of aircraft grade aluminum and 313 stainless steel

6. The device according to claim 1, wherein said handle has a knurled rip for secure grip.

7. The device according to claim 6, wherein said handle is made from polyoxymethelene (polyacetal) thermoplastic material for durability.

8. The device according claim 1, wherein said handle and shaft are made as a single piece of stock using preferably aircraft grade aluminum.

9. The device according to claim 1, wherein said blade is fastened to said shaft by either a machine screw or a rivet.
